(19) United States
(12) Patent Application Publication
(10) Pub. No.: US 2003/0159410 A1
(43) Pub. Date: Aug. 28, 2003

(54) Horse-rug

(76) Inventor: Renee Van Campenhoudt, Humbeek (BE)

Correspondence Address: BROWDY AND NEIMARK, P.L.L.C., 624 NINTH STREET, NW, SUITE 300, WASHINGTON, DC, 20001-5303, US

(21) Appl. No.: 10/257,268

(22) PCT Filed: Apr. 10, 2001
(86) PCT No.: PCT/BE01/00062

(30) Foreign Application Priority Data
Apr. 10, 2000 (BE) 20000249

(51) Int. Cl. B68C 5/00

(52) U.S. Cl. 54/79.1

(57) ABSTRACT

Horse-rug that contains at least two parts (1) and (2) and connectors (3) for divisibly at taching said parts to each others.

The invention relates to a horse-rug.

Horse-rug means a mostly rectangular size, relatively thick and mainly padded quilt or quilted coverlet or blanket which covers the horse's back and side-flanks, neck and belly. Horse-rugs are mainly used to cover the horse for insulation against cold, with esthetical means and/or for protection against dirt and changing climatically circumstances.

The current sizes and volumes of existing horse-rugs do not allow the easy cleaning by use of a standard household washing machine. These washing machines have generally a volume of 20 to 50 litres and allow a load of maximal 2,5 to 10 kg. Consequently, current horse-rugs do require cleaning by a specialised company (cleaner, dry-cleaner etc. ). This is not only very costly but is in addition very time consuming. The horse-rug has indeed to go back and forth to the cleaner.

The object of the invention is mainly to avoid such inconvenience and to allow easy cleaning in a standard household washing machine.

A further object of the invention is to construct a horse-rug that is easy to handle without affecting the normal properties of the horse-rug such as insulation, waterproof, windproof.

The above mentioned objects are realised by a horse-rug having the specific features set out in claim 1. Specific features for preferred embodiments of the invention are set out in the dependent claims.

The horse-rug, according to an embodiment of the invention, is constructed such that it is dividable in at least two parts, which are divisibly attached together with the aid of connectors.

These connectors enable to connect and disconnect the different parts of the horse-rug. Possible connectors for releasable attaching the different parts of the horse-rug are buttons, push-buttons, zipper fastener and or auto-attaching tape better known under the commercial name Velcro®.

For two parts of the horse-rug, a ratio of size can be defined as being the quotient of the surface area of one part and the surface area of the other part.

According to a possible embodiment of the invention, the horse-rug comprises two parts having a ratio of size which is between 50% and 200%, preferably 75% and 150%, more preferably 75% and 125%, even more preferably 90% and 110%.

According to a more specific embodiment of the invention, the horse-rug consists of mainly two releasable attached parts with approximately identical size, e.g. having a ratio of size of approximately 100%.

According to a preferred embodiment of the invention, the horse-rug contains two parts wherein the first part covers the shoulders, the front-part of the ribs and side-flanks of the horse and the second part covers the back, the loins, the croup, the rear-part of the ribs and side-flanks of the horse.

According to this preferred embodiment of the invention, the connectors are provided with protectors in order to protect the horse from the solid elements of the connectors and consequently to protect it from injury. These protectors, possibly, comprise a covering overlap extending from one of the parts of the horse-rug that are connected to each other.

Other particularities and advantages of the invention will become clear in the below detailed description of a specific embodiment of the invention. The description is only exemplary and does under no circumstances limit the extent and other embodiments of the invention. The reference numbers have direct reference to the attached figures.

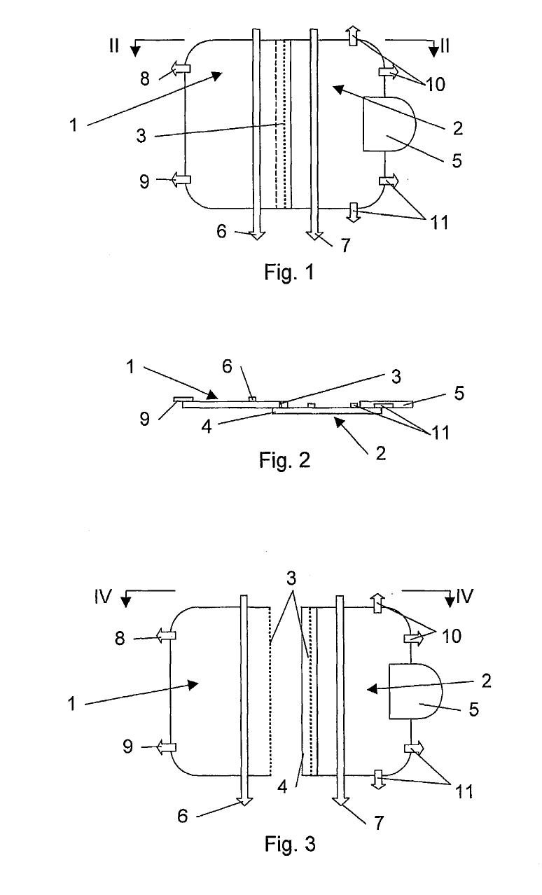

FIG. 1 is a schematic representation of the top-view of a horse-rug according to a preferred embodiment of the invention, wherein two individual parts are releasable attached to each other.

FIG. 2 is a schematic representation of the side-view according to the line II-II of the embodiment as represented in FIG. 1.

FIG. 3 is a schematic representation of the top-view of the embodiment of the horse-rug as represented in FIG. 1, wherein the two individual parts are detached from each other.

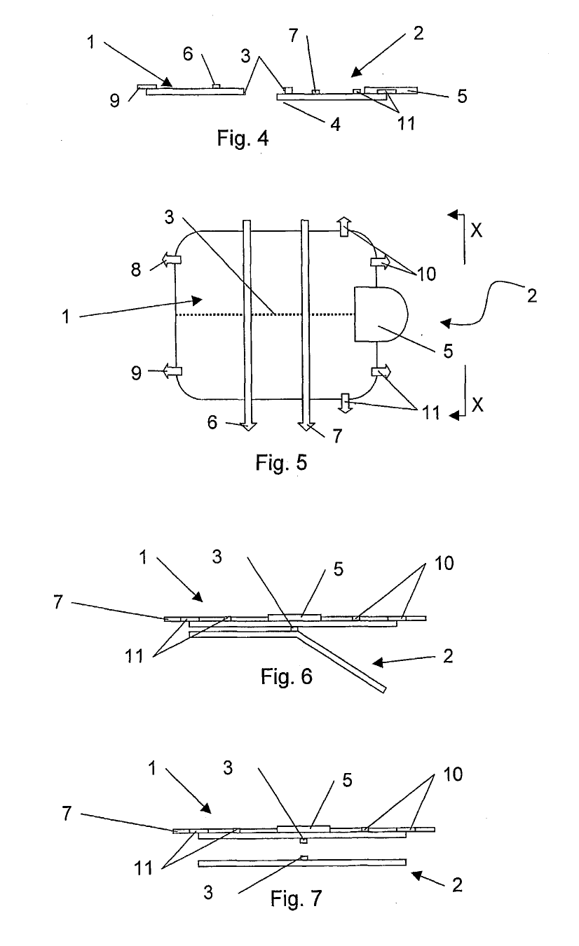

FIG. 4 is a schematic representation of the side-view according to line IV-IV of FIG. 3.

FIG. 5 is a schematic representation of the top-view of a horse-rug according to another embodiment of the invention.

FIG. 6 is a schematic representation of the back-view according to line X-X of the embodiment of the horse-rug as represented in FIG. 5, wherein the two individual parts are releasable attached to each other.

FIG. 7 is a schematic representation of the back-view according to the line X-X of the embodiment as represented in FIG. 5, wherein the two individual parts are detached from each other.

The same reference numbers in the various figures refer to the same elements.

In general, the current invention relates to a horse-rug comprising parts that are releasable attached together.

A horse-rug, according to a preferred embodiment of the invention, comprises two parts, a first part 1 and a second part 2, as represented in FIGS. 1 and 2.

The first part 1 is the front-part of the horse-rug and the second part 2 is the rear-part. Both parts are releasable attached together by connectors 3, which may comprise buttons, push-buttons, zipper fastener or auto-attaching tape better know under the commercial name Velcro®.

Parts 1 and 2 have approximately the same size resulting in a ratio of size of part 1 to part 2 of approximately 100%.

The front-part 1 is stretching from the horse's neck towards, for instance, almost near the middle of the horse's back. The rear-part 2 stretches from the rniddle of the horse's back towards the horse's tail. In this respect, the connectors 3 are arranged in such a way that when the horse-rug is properly put onto a horse, these connectors 3 are extending along a direction, which is transversal to the horse's backbone. More specifically, these connectors 3 are aligned aliost perpendicular to the horse's backbone.

By detaching the connectors 3, two independent parts 1 and 2 of the horse-rug are obtained, as represented in FIGS. 3 and 4.

An overlap 4 reaches out from underneath the connectors 3 from the rear-part 2 and protects the horse against pressure from possible solid elements of the connectors as represented in FIGS. 2 and 4.

On the rear-part 2 of the horse-rug, a tail-protection part 5 covers and protects the horse's tail.

Furthermore, on each of the parts 1 and 2 a belt with a buckle 6, respectively 7, is attached to the horse-rug in order to attach the latter sideways against the horse's belly. More specifically, these belts 6 and 7 are positioned around the horse's belly.

In an analogue way, there are two fastenings 8 and 9 foreseen on the front-part 1 of the horse-rug in order to maintain this part in position around the horse's neck.

In a similar analogue way, there are two fastenings 10 and 11 foreseen on the rear-part 2, to be attached around the horse's rear-legs, in order to maintain this part in position at the rear-end.

Because the horse-rug comprises two parts, namely parts 1 and 2, these can not only be fitted separately into a household washing machine in order to be easily cleaned but can also be manageable stored. This results from the fact that, in the case of the above preferred embodiment of horse-rug according to the invention, the parts 1 and 2 have a reduced surface, which is 50% of the surface of the complete horse-rug, and also a reduced volume, which is 50% of the volume of the complete horse-rug if the density of both parts 1 and 2 is the same.

Another interesting embodiment of a horse-rug according to the invention, comprises two parts 1 and 2 with nearly identical shape and size, which can be releasable attached together such that the first part 1 completely overlaps the second part 2 as represented in FIGS. 5, 6 and 7.

The first part 1 is the upper-part while the second part 2 is the lower-part of the horse-rug. In this case the ratio of size of part 1 to part 2 is 100%.

Both parts 1 and 2 extend from the horse's neck towards the horse's tail.

The upper-part 1 and the lower-part 2 are releasable connected by connectors 3, which are located between the parts 1 and 2, in the middle of the parts 1 and 2, and parallel with the horse's backbone. When the horse-rug is positioned onto the horse, the connectors 3 are aligned above the horse's backbone.

Furthermore, as in the above preferred embodiment, fastenings 6 to 11 are provide in order to attach the horse-rug onto the horse.

In the case of the above interesting embodiment of the invention, the parts 1 and 2 have the same surface area as the complete horse-rug but these have a reduced volume, which is 50% of the volume of the complete horse-rug if the density of both parts is the same. Both parts can easier be handled and stored compared to the complete horse-rug since the volume and also the weight are reduced.

The invention is obviously not restricted to the above mentioned description and to the design as specified in the individual figures. Within the framework of the invention several alternative embodiments can be considered such as the number of detachable parts, the design of the detachable parts, the way of connecting the detachable parts as well as the position of the detachable parts in relation to each other. As such, the horse-rug can consist of more than two parts, which are releasable attached together.

1. Horse-rug that covers the horse's back and its side-flanks, and that comprises at least two parts, a first part (1) and a second part (2), and connectors (3) for releasable attaching said parts characterised in that the parts (1, 2) are attached to each other and extending in prolongation of each other.

2. Horse-rug according to claim 1, wherein said first part (1) is a front-part and said second part (2) is a rear-part.

3. Horse-rug according to claim 1 or 2, with two parts (1, 2) having a ratio of size between 50% and 200%.

4. Horse-rug according to claim 2 or 3, wherein one of said parts (1, 2) comprises at least two subparts and connectors (3) for releasable attaching these subparts to each other.

5. Horse-rug according to one of the claims 1 to 4, wherein said connectors (3) are extending along a direction which is transverse to the horse's backbone.

6. Horse-rug according to one of the claims 1 to 5, wherein said first part (1) covers the shoulders, the front-part of the ribs and side-flanks of the horse and said second part (2) covers the back, the loins, the croup, the rear-part of the ribs and side-flanks of the horse.

7. Horse-rug according to one of the claims 1 to 6, wherein said connectors (3) are provided with protectors (4) for protecting the horse from injury.

8. Horse-rug according to claim 7, wherein said protectors (4) comprises an overlap extending from one of the parts that are connected to each other by means of said connectors (3).

9. Horse-rug according to one of the claims I to 8, wherein said connectors (3) are selected from the group consisting of buttons, push-buttons, zipper fastener and/or auto-attaching tape.
